(19) United States
(12) Patent Application Publication
(10) Pub. No.: US 2026/0341091 A1
(43) Pub. Date: Oct. 29, 2026

(54) AUTOMATIC TELLER MACHINE

(71) Applicant: HYOSUNG TNS INC., Seoul (KR)

(72) Inventors: Sung Chang HUR, Seoul (KR); Myungwoo LEE, Seoul (KR); Seungsik JEONG, Seoul (KR); Youngho HAN, Seoul (KR)

(21) Appl. No.: 19/414,509

(22) Filed: Feb. 9, 2026

(30) Foreign Application Priority Data
Dec. 13, 2024 (KR) 10-2024-0185955

(51) Int. Cl. G07D 11/14; B65H 5/00; B65H 5/06; B65H 7/02; B65H 9/10; B65H 11/00; G07D 11/18; G07D 11/22

(52) U.S. Cl. CPC G07D 11/14; B65H 5/006; B65H 5/06; B65H 7/02; B65H 9/101; B65H 11/00; G07D 11/18; G07D 11/22; B65H 2301/4222; B65H 2301/42264; B65H 2301/44324; G07D 2207/00; G07D 2211/00

(57) ABSTRACT

An automated teller machine includes: a deposit and withdrawal unit configured to allow a media bundle, in which a plurality of media are stacked, to be deposited or withdrawn; a discrimination unit configured to discriminate the media; and a controller configured to control the deposit and withdrawal unit and the discrimination unit. The deposit and withdrawal unit includes: a push plate arranged to be vertically movable so that the media bundle may be placed thereon; and a media alignment unit disposed to be movable in a width direction of the push plate and configured to align the media bundle to a center of the push plate by moving in the width direction of the push plate in conjunction with raising and lowering of the push plate.

### TECHNICAL FIELD

The present disclosure relates to an automated teller machine.

### BACKGROUND

In general, an automated teller machine includes devices such as a cash dispenser unit (CDU) and a bill recycling machine (BRM), which have been developed to provide most financial services in an unmanned, quick, and convenient manner without time constraints, excluding consultation services.

Such an automated teller machine may be additionally provided with various components according to the function of the financial service, such as a card processing unit, a passbook processing unit, and a check deposit machine, in addition to the cash deposit/withdrawal function. An automated teller machine may accept a deposit of a media bundle in which a plurality of media such as banknotes are stacked, and when a media bundle is deposited, the automated teller machine must separate the media bundle into single sheets for transport.

However, in the case of a machine in which a media bundle is deposited horizontally, the configuration for separating the deposited media bundle and conveying it as single sheets was relatively complex. Furthermore, when a media bundle is inserted into the deposit and withdrawal unit, a phenomenon occurs in which the media bundle is not properly aligned to the center of the insertion space of the deposit and withdrawal unit.

### SUMMARY

The embodiment of the present disclosure has been devised in view of the above-described background, and are intended to provide an automated teller machine capable of aligning a media bundle inserted into a deposit and withdrawal unit to a central position.

In accordance with an aspect of the present disclosure, there is provided an automated teller machine including: a deposit and withdrawal unit configured to allow a media bundle, in which a plurality of media are stacked, to be deposited or withdrawn; a discrimination unit configured to discriminate the media; and a controller configured to control the deposit and withdrawal unit and the discrimination unit, wherein the deposit and withdrawal unit includes: a push plate arranged to be vertically movable so that the media bundle may be placed thereon; and a media alignment unit disposed to be movable in a width direction of the push plate and configured to align the media bundle to a center of the push plate by moving in the width direction of the push plate in conjunction with raising and lowering of the push plate.

Further, the media alignment unit may include: a first side guide disposed in one side of the push plate and movable in the width direction of the push plate; a second side guide disposed in the other side of the push plate and movable in the width direction of the push plate; a torsion spring for providing an elastic force to at least one of the first side guide and the second side guide in a first direction in which the first side guide and the second side guide move closer to each other; and a rotating lever for moving the first side guide and the second side guide in a second direction in which the first side guide and the second side guide move away from each other when the push plate is lowered.

Further, the automated teller machine may further include: a first rack gear formed on the first side guide; a second rack gear formed on the second side guide; and an alignment pinion gear engaged with the first rack gear and the second rack gear, wherein the alignment pinion gear, when rotated, interlockingly moves the first side guide and the second side guide in the first direction or the second direction.

Further, the first side guide or the second side guide may be supported to be elastically pressed by at least a portion of the torsion spring.

Further, the rotating lever, when the push plate is lowered, may provide a pushing force greater than an elastic force of the torsion spring to the first side guide or the second side guide so that the first side guide and the second side guide move in the second direction.

Further, the deposit and withdrawal unit may further include: a first pickup roller for conveying the media bundle in a media deposit direction when the media bundle is placed on the push plate; a second pickup roller spaced apart from the first pickup roller in the deposit direction and configured to supply the media of the media bundle to a single sheet conveyance unit; a first media detection sensor for detecting whether at least a portion of the media bundle has reached an area directly above the push plate; a second media detection sensor for detecting whether at least a portion of the media bundle has reached a standby state before being fed into the single sheet conveyance unit; a first elevating drive unit for raising and lowering the first pickup roller; and a second elevating drive unit for raising and lowering the second pickup roller.

Further, the controller may control the first elevating drive unit to lower the first pickup roller to contact the media bundle when the first media detection sensor detects the media bundle, and control the second elevating drive unit to lower the second pickup roller to contact an upper surface of the media bundle and to raise the push plate to push the media bundle upward when the second media detection sensor detects the media bundle.

According to the embodiments of the present disclosure, when a media bundle is inserted into a deposit/withdrawal unit, a media alignment unit pushes the left and right sides of the media bundle, thereby providing the effect of being able to align the media bundle to the center in an insertion space of the deposit/withdrawal unit.

Furthermore, according to the embodiments of the present disclosure, there is an effect that the configuration for separating a media bundle, in which a plurality of media such as banknotes are stacked, and conveying the media as single sheets is relatively simple.

### BRIEF DESCRIPTION OF THE DRAWINGS

FIG. 1 is a diagram illustrating an automated teller machine according to an embodiment of the present disclosure.

FIG. 2 is a perspective view of the automated teller machine of FIG. 1 with a deposit and withdrawal unit removed.

FIG. 3 is a cross-sectional view taken along the line “III-III” of FIG. 2.

FIG. 4 is a cross-sectional view taken along the line “IV-IV′” of FIG. 2.

FIG. 5 is a cross-sectional view taken along the line “V-V′” of FIG. 2.

FIG. 6 is a cross-sectional view taken along the line “VI-VI′” of FIG. 2.

FIG. 7 is a cross-sectional view taken along the line “VII-VII′” of FIG. 2.

FIG. 8 is a cross-sectional view taken along the line “IX-IX′” of FIG. 2.

FIG. 9 is a diagram illustrating a state in which a media bundle of FIG. 7 has completed alignment to the center.

FIG. 10 is a diagram illustrating a state in which the media bundle of FIG. 8 has completed alignment to the central position.

FIG. 11 is a diagram illustrating a state before the media bundle is aligned to the central position in the automated teller machine according to the embodiment of the present disclosure.

FIG. 12 is a diagram illustrating a state in which a media bundle has completed alignment to the center in an automated teller machine according to the embodiment of the present disclosure.

### DETAILED DESCRIPTION

Hereinafter, specific embodiments for implementing the technical ideas of the present disclosure will be described in detail with reference to the drawings. In addition, in describing the present disclosure, when it is determined that a detailed description of the relevant known configuration or function may obscure the main idea of the present disclosure, the detailed description thereof will be omitted.

Further, when a component is mentioned to be “connected to” “supported by”, “transferred to” or “in contact with” another component, it should be understood that it may be directly connected to, supported by, transfer to, or in contact with another component, but there may be other components therebetween.

The terms used in the present specification are used merely to describe the specific embodiments and are not intended to limit the present disclosure. Singular expressions include the plural unless the context clearly indicates otherwise.

Further, in the present specification, it should be noted that expressions such as upper side, lower side, upper portion, lower portion, and the like are described with reference to the drawings and may be expressed differently when the orientation of the subject matter is changed. Similarly, in the accompanying drawings, some components are exaggerated, omitted, or shown schematically, and the dimensions of each component do not necessarily reflect actual dimensions.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

Hereinafter, a specific configuration of an automated teller machine according to an exemplary embodiment will be described.

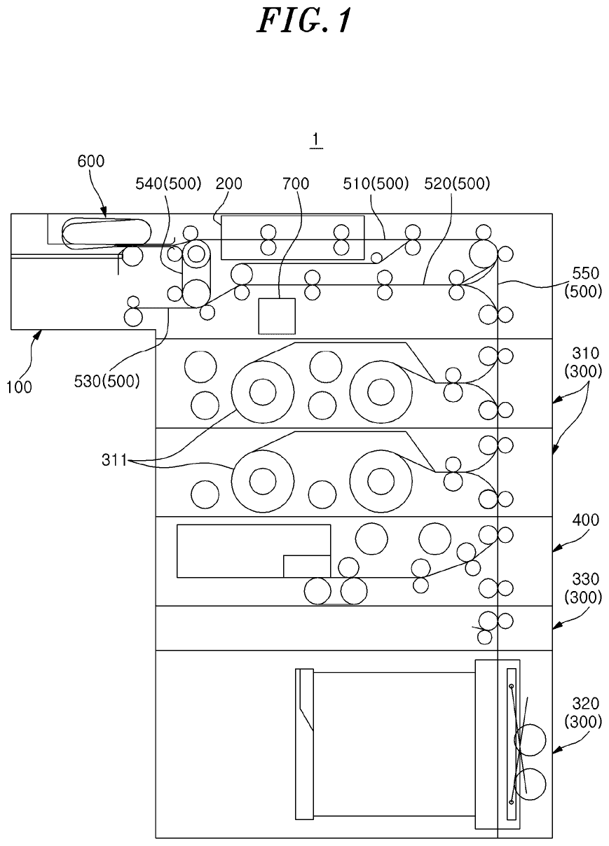

Referring to FIG. 1, an automated teller machine 1 may accept a deposit of a media bundle in which a plurality of media are stacked, and may convey stored media to withdraw the media to a user. The automated teller machine 1 may include a deposit and withdrawal unit 100, a discrimination unit 200, a storage unit 300, a media replenishment unit 400, a conveyance path 500, a single sheet transport unit 600, and a controller 700.

The deposit and withdrawal unit 100 may allow a media bundle, in which a plurality of media are stacked, to be deposited and withdrawn. When a single sheet of media is conveyed from the media bundle to a point where the single sheet transport unit 600 is located, the deposit and withdrawal unit 100 conveys the media by contacting it at two points, thereby preventing a skewing of the media. Details of the deposit and withdrawal unit 100 will be described later.

The discrimination unit 200 may discriminate the media. The discrimination unit 200 may discriminate the media conveyed as single sheets from the deposit and withdrawal unit 100 via the conveyance path 500. Furthermore, when media is replenished into the storage unit 300 via the media replenishment unit 400, the discrimination unit 200 may discriminate the media before it is stored in the storage unit 300. The discrimination unit 200 may discriminate the media for abnormalities, determine its denomination, and count the media. The discrimination unit 200 classifies the media into a normal banknote and an abnormal banknote according to a discrimination result, and may classify the normal banknote into a non-recirculating banknote and a recirculating banknote. Here, the abnormal banknote refers to media that cannot be processed for deposit, and may include old media whose image cannot be read, folded media, counterfeit bills, and suspicious bills. The non-recirculating banknote refers to media used only for deposit and not for withdrawal, and the recirculating banknote refers to media used for both deposit and withdrawal. The non-recirculating banknote and recirculating banknote may be classified based on the monetary value according to the denomination of the media. The recirculating banknote may be set as a relatively low-denomination note, and the non-recirculating banknote may be set as a relatively high-denomination note. Meanwhile, the non-recirculating banknote may also be designated by a user.

The storage unit 300 may store media. Media may be stored in the storage unit 300 according to the discrimination result from the discrimination unit 200. The storage unit 300 may include a recirculating banknote storage unit 310, a non-recirculating banknote storage unit 320, and a counterfeit bill storage unit 330. In the recirculating banknote storage unit 310, media discriminated as the recirculating banknote by the discrimination unit 200 may be stored. The recirculating banknote storage unit 310, including a media storage drum 311, may be configured such that the recirculating banknote are wound on and stored in the media storage drum 311 via a tape (not shown). In the non-recirculating banknote storage unit 320, media discriminated as the non-recirculating banknote by the discrimination unit 200 may be stored. In the counterfeit bill storage unit 330, media discriminated as counterfeit bills among the media discriminated as the abnormal banknote by the discrimination unit 200 may be stored. The media replenishment unit 400 may replenish the storage unit 300 with media. The media replenishment unit 400 may replenish the recirculating banknote storage unit 310 of the storage unit 300 with the recirculating banknote.

The conveyance path 500 may convey media among the deposit and withdrawal unit 100, the discrimination unit 200, the storage unit 300, and the single sheet transport unit 600. The conveyance path 500 may include a deposit conveyance path 510, a withdrawal conveyance path 520, an ejection conveyance path 530, a return conveyance path 540, and a gate 550. The deposit conveyance path 510 may convey media among the deposit and withdrawal unit 100, the discrimination unit 200, the storage unit 300, and the single sheet transport unit 600. The deposit conveyance path 510 may be connected to the deposit and withdrawal unit 100, the discrimination unit 200, the storage unit 300, and the single sheet transport unit 600. The withdrawal conveyance path 520 may convey media between the deposit and withdrawal unit 100 and the storage unit 300. The withdrawal conveyance path 520 may be connected to the deposit and withdrawal unit 100 and the storage unit 300. The withdrawal conveyance path 520 may be connected to the storage unit 300 via the gate 550. The ejection conveyance path 530 may convey media such that media conveyed via the withdrawal conveyance path 520 is ejected to the outside of the deposit and withdrawal unit 100. The ejection conveyance path 530 may be connected to the deposit and withdrawal unit 100 and the withdrawal conveyance path 520. When media is discriminated by the discrimination unit 200 before being replenished into the storage unit 300 via the media replenishment unit 400, the return conveyance path 540 allows the media discriminated by the discrimination unit 200 to wait and then be conveyed back to the discrimination unit 200. The return conveyance path 540 may extend between the deposit conveyance path 510 and the withdrawal conveyance path 520 toward the withdrawal conveyance path 520. A gate 550 may connect the deposit conveyance path 510 to the storage unit 300, connect the withdrawal conveyance path 520 to the storage unit 300, or connect the deposit conveyance path 510 to the withdrawal conveyance path 520.

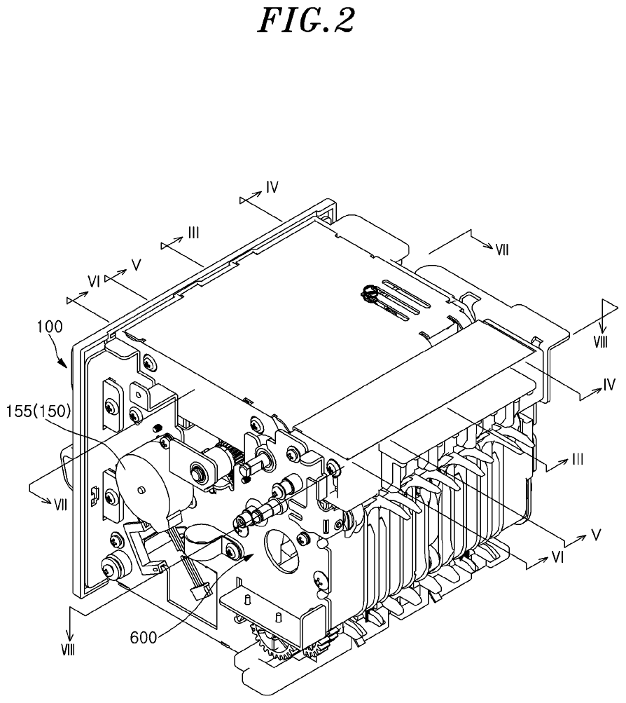

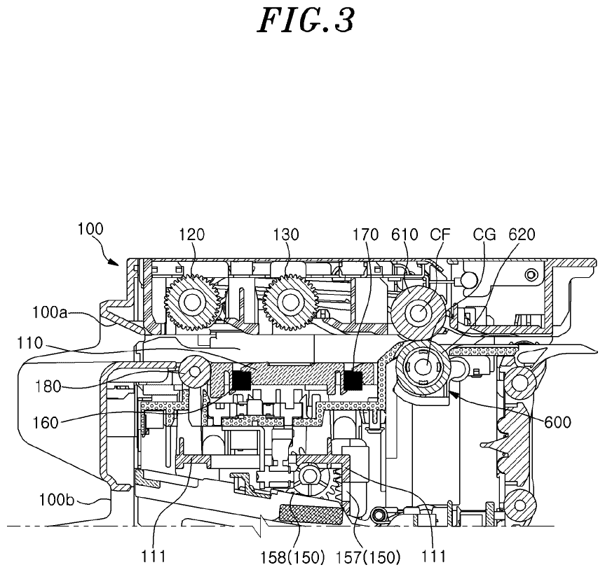

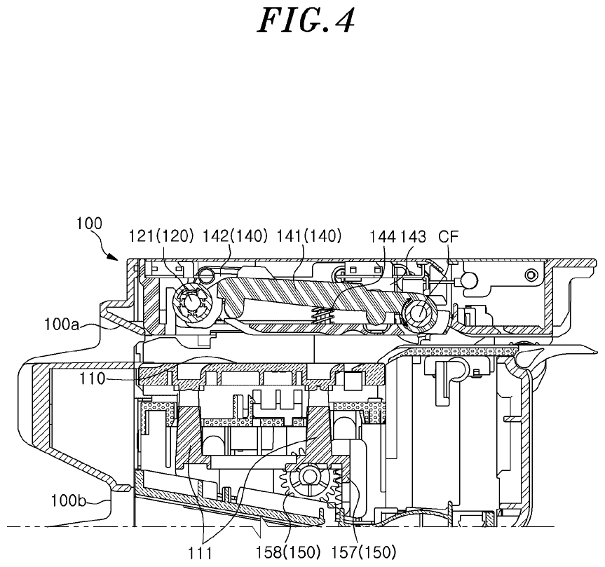

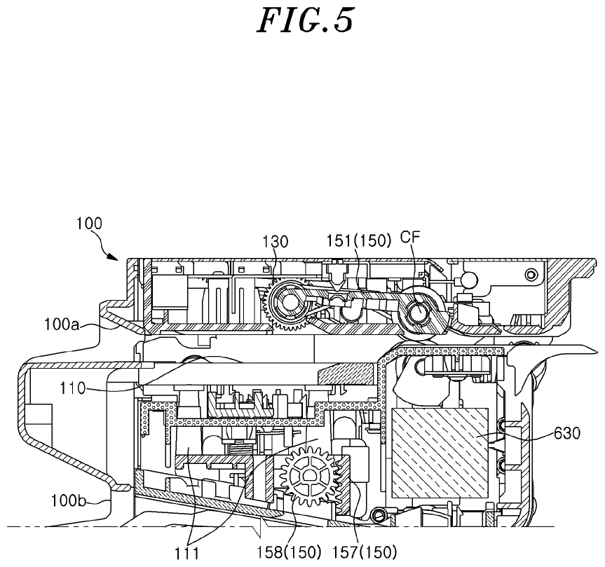

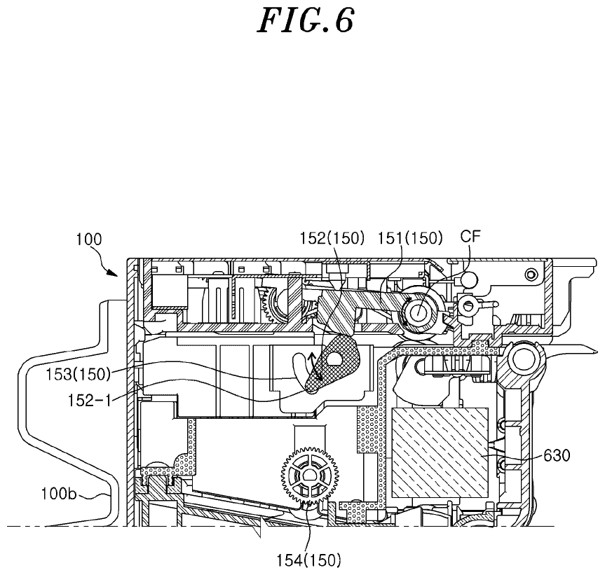

Referring to FIGS. 2 to 6, the single sheet transport unit 600 may convey the media one sheet at a time. The single sheet transport unit 600 may convey media deposited in the deposit and withdrawal unit 100 to the discrimination unit 200 one sheet at a time. The single sheet transport unit 600 may be disposed between the deposit and withdrawal unit 100 and the discrimination unit 200, and closer to the deposit and withdrawal unit 100 than to the discrimination unit 200. The single sheet transport unit 600 may include a feed roller 610, a gate roller 620, and a roller rotation drive unit 630. The feed roller 610 may convey media one sheet at a time together with the gate roller 620. The feed roller 610 may be rotated by the roller rotation drive unit 630. The gate roller 620 may convey media one sheet at a time together with the feed roller 610. A center of rotation CG of the gate roller 620 may be disposed to be spaced apart in a media conveyance direction from a virtual line that passes through a center of rotation CF of the feed roller 610 and is perpendicular to the media conveyance direction. The roller rotation drive unit 630 may rotate the feed roller 610. The roller rotation drive unit 630 may rotate a first pickup roller 120 and a second pickup roller 130.

The controller 700 may control the deposit and withdrawal unit 100, the discrimination unit 200, the storage unit 300, the media replenishment unit 400, the conveyance path 500, and the single sheet transport unit 600. The controller 700 may control a first elevating drive unit 140 and a second elevating drive unit 150 of the deposit and withdrawal unit 100. Furthermore, the controller 700 may control the roller rotation drive unit 630. The controller 700 may be connected to a link drive cylinder of the first elevating drive unit 140 to control the link drive cylinder. Furthermore, the controller 700 may be connected to a roller rotation drive motor 652 of the roller rotation drive unit 630 to control the roller rotation drive motor 652.

The controller 700 may control the first elevating drive unit 140 and the second elevating drive unit 150 based on detection by at least one of a first media detection sensor 160 and a second media detection sensor 170 of the deposit and withdrawal unit 100. When the first media detection sensor 160 detects a media bundle, the controller 700 may control the first elevating drive unit 140 to cause the first pickup roller 120 to be lowered to contact the media bundle. Furthermore, when the second media detection sensor 170 detects the media bundle, the controller 700 may control the second elevating drive unit 150 to cause the second pickup roller 130 to be lowered to contact the media, and may control the second elevating drive unit 150 to lower the second pickup roller 130 to contact an upper surface of the media bundle and raise a push plate 110 to push the media bundle upward.

When media is conveyed to the single sheet transport unit 600, the controller 700 may control the first elevating drive unit 140 and the second elevating drive unit 150 of the deposit and withdrawal unit 100 such that the first pickup roller 120 and the second pickup roller 130 are operated together. When the first media detection sensor 160 detects the media bundle, the controller 700 may control the first elevating drive unit 140 to cause the first pickup roller 120 to be lowered to contact the media bundle, and when the second media detection sensor 170 detects the media bundle, the controller 700 may control the second elevating drive unit 150 such that the second pickup roller 130 is lowered and the push plate 110 is simultaneously raised to contact the media bundle. When the push plate 110 is lowered, a rotating lever 194 may move a first side guide 191 and a second side guide 192 in a second direction in which the first side guide 191 and the second side guide 192 move away from each other. The controller 700 may be implemented by a computing device including a microprocessor, a memory, and the like, and since the implementation method thereof is obvious to those skilled in the art, a more detailed description thereof will be omitted.

Hereinafter, the deposit and withdrawal unit according to the automated teller machine will be described in detail.

Referring again to FIGS. 1 to 6, when a media bundle 2 in which individual media 2-1 are stacked is deposited, the deposit and withdrawal unit 100 may guide the media bundle 2 in a horizontal direction. A deposit port 100a and a withdrawal port 100b may be formed in the deposit and withdrawal unit 100. The deposit port 100a may be a deposit-only port, and the withdrawal port 100b may be a withdrawal-only port. The deposit and withdrawal unit 100 may include a push plate 110, a first pickup roller 120, a second pickup roller 130, a first elevating drive unit 140, a second elevating drive unit 150, a first media detection sensor 160, a second media detection sensor 170, and a conveyance assist roller 180.

A media bundle 2 may be placed on the push plate 110. The push plate 110 may extend in the deposit direction, which is the direction toward the discrimination unit 200. The media bundle 2 may be placed on the push plate 110 by a user (not shown) through the deposit port 100a. For example, the media bundle 2 may be placed on an upper surface of the push plate 110. The push plate 110 may be raised and lowered by the second elevating drive unit 150. The push plate 110 may be supported by a plate supporter 111. A plate support protrusion 112 that pushes a rotating lever 194 when the push plate 110 is raised or lowered may be formed on the plate supporter 111.

When the media bundle 2 is placed on the push plate 110, the first pickup roller 120 may convey the media bundle 2 in the deposit direction. The first pickup roller 120 may convey the media bundle 2 in the deposit direction together with the conveyance assist roller 180. The first pickup roller 120 may be disposed above the push plate 110 and may be raised and lowered by the first elevating drive unit 140. The first pickup roller 120 may be rotated by the roller rotation drive unit 630 included in the single sheet transport unit 600. The first pickup roller 120 may be disposed closer to the deposit port 100a than the second pickup roller 130. A first roller shaft 121 of the first pickup roller 120 may be rotatably disposed on one side of a first elevating support arm 141.

The second pickup roller 130 may convey the media 2-1 from the media bundle 2 in the deposit direction. The second pickup roller 130 may convey the media 2-1 in the deposit direction from the media bundle 2 that has been conveyed in the deposit direction from the push plate 110 by the first pickup roller 120. The second pickup roller 130 may be disposed to be spaced apart from the first pickup roller 120 in the deposit direction. The second pickup roller 130 may be disposed farther from the deposit port 100a than the first pickup roller 120. The second pickup roller 130 is disposed above the push plate 110 and may be raised and lowered by the second elevating drive unit 150. Furthermore, the second pickup roller 130 may be rotated by the roller rotation drive unit 630.

The first elevating drive unit 140 may raise and lower the first pickup roller 120. When the first pickup roller 120 is raised by the first elevating drive unit 140, the first pickup roller 120 may not contact the media bundle 2 placed on the push plate 110. Furthermore, when the first pickup roller 120 is lowered by the first elevating drive unit 140, the first pickup roller 120 may contact the media bundle 2 placed on the push plate 110. The first elevating drive unit 140 is connected to the controller 700 and may be controlled by the controller 700. The first elevating drive unit 140 may include a first elevating support arm 141, an elevating link 142, a link drive cylinder 143, and a first elastic spring 144.

The first pickup roller 120 may be rotatably disposed on one side of the first elevating support arm 141. Furthermore, the other side of the first elevating support arm 141 may be rotatable about a first arm rotation center. As the other side of the first elevating support arm 141 is rotated about the first arm rotation center, the first pickup roller 120 may be raised and lowered. In one embodiment, the first arm rotation center may be the same as the center of rotation CF of a feed roller 610, which will be described later, included in the single sheet transport unit 600. In other words, the other side of the first elevating support arm 141 may be rotatably disposed on a rotation shaft of the feed roller 610.

The elevating link 142 may be connected to the first elevating support arm 141. A plurality of elevating links 142 may be provided. Furthermore, the plurality of elevating links 142 are connected to each other, and one of the plurality of elevating links 142 may be connected to the first elevating support arm 141. Furthermore, another of the plurality of elevating links 142 may be connected to the link drive cylinder 143.

The link drive cylinder 143 may drive the elevating link 142. By the driving of the elevating link 142 by the link drive cylinder 143, the other side of the first elevating support arm 141 is rotated about the first arm rotation center, and the first pickup roller 120 may be raised and lowered. The link drive cylinder 143 may be connected to the elevating link 142. A cylinder rod of the link drive cylinder 143 may be connected to the elevating link 142. When a plurality of elevating links 142 are provided, the link drive cylinder 143 may be connected to one of the plurality of elevating links 142 other than the elevating link 142 connected to the first elevating support arm 141. The link drive cylinder 143 is connected to the controller 700 and may be controlled by the controller 700.

The second elevating drive unit 150 may raise and lower the second pickup roller 130 using an elevating cam 152. When the second pickup roller 130 is raised by the second elevating drive unit 150, the second pickup roller 130 may not contact the media bundle 2 placed on the push plate 110. Furthermore, when the second pickup roller 130 is lowered by the second elevating drive unit 150, the second pickup roller 130 may contact the media bundle 2 placed on the push plate 110.

The second elevating drive unit 150 may raise and lower the push plate 110 using a rack gear 157 and a pinion gear 158. By the raising and lowering of the push plate 110 by the second elevating drive unit 150, the push plate 110 may move closer to or farther away from the first pickup roller 120 and the second pickup roller 130. The second elevating drive unit 150 is connected to the controller 700 and may be controlled by the controller 700. The second elevating drive unit 150 may include a second elevating support arm 151, an elevating cam 152, a stopper 153, a plate elevating gear 154, an elevating drive motor 155, a rack gear 157, a pinion gear 158, and a second elastic spring.

The second pickup roller 130 may be rotatably disposed on one side of the second elevating support arm 151. Furthermore, the other side of the second elevating support arm 151 may be rotatable about a second arm rotation center. As the other side of the second elevating support arm 151 is rotated about the second arm rotation center, the second pickup roller 130 may be raised and lowered. In one embodiment, the second arm rotation center may be the same as the center of rotation of the feed roller 610. In other words, the other side of the first elevating support arm 141 may be rotatably disposed on the rotation shaft of the feed roller 610.

The elevating cam 152 may raise and lower the second elevating support arm 151. The elevating cam 152 may be rotated, and the second elevating support arm 151 may be raised and lowered according to a rotational position of the elevating cam 152. A stopper engaging part 152-1 that moves along the stopper 153 may be formed on the elevating cam 152. In addition, a range of rotation of the elevating cam 152 may be limited by the stopper 153 and the stopper engaging part 152-1. In other words, the elevating cam 152 may be rotated within a predetermined range of rotation.

The stopper 153 may limit the range of rotation of the elevating cam 152. In other words, the stopper 153 may limit the elevating cam 152 to rotate within a predetermined range of rotation. In one embodiment, the stopper 153 may be an arc-shaped groove into which the stopper engaging part 152-1 of the elevating cam 152 may be inserted.

The plate elevating gear 154 may transmit a rotational force of the elevating drive motor 155 to the pinion gear 158. The plate elevating gear 154 may be connected to the pinion gear 158. The plate elevating gear 154 may be connected to a rotation shaft of the pinion gear 158.

The elevating drive motor 155 may provide a rotational force. The elevating drive motor 155 may provide a rotational force for rotating the elevating cam 152 so that the second elevating support arm 151 is raised and lowered. The rotational force of the elevating drive motor 155 may be transmitted to the elevating cam 152 through an arm elevating gear. A plurality of arm elevating gears may be provided. The plurality of arm elevating gears are engaged with each other, one of the plurality of arm elevating gears may be connected to the elevating cam 152 and another may be connected to the elevating drive motor 155. One of the plurality of arm elevating gears may be connected to a rotation shaft of the elevating cam 152, and another may be connected to a rotation shaft of the elevating drive motor 155.

The elevating drive motor 155 may provide a rotational force for rotating the pinion gear 158 so that the push plate 110 is raised and lowered. The rotational force of the elevating drive motor 155 may be transmitted to the elevating cam 152 through the arm elevating gear. The elevating drive motor 155 may be connected to one of the plurality of arm elevating gears. The elevating drive motor 155 may be connected to one of the plurality of arm elevating gears other than the arm elevating gear connected to the elevating cam 152. The elevating drive motor 155 is connected to the controller 700 and may be controlled by the controller 700.

The rack gear 157 may raise and lower the push plate 110 together with the pinion gear 158. The rack gear 157 may be disposed on the push plate 110. The rack gear 157 may be disposed on the push plate 110 so as to extend in the raising/lowering direction of the push plate 110.

The pinion gear 158 may raise and lower the push plate 110 together with the rack gear 157. The pinion gear 158 may be engaged with the rack gear 157 to move along the rack gear 157. The second elastic spring may provide an elastic force to the second elevating support arm 151 in a direction for pressing the second pickup roller 130 against the media bundle 2. For example, when the second elevating support arm 151 is rotated downward by the rotation of the elevating cam 152, the second pickup roller 130 may be brought into contact with the media bundle 2 to be pressed thereagainst by the elastic force of the second elastic spring.

The first media detection sensor 160 may detect whether the media bundle 2 has reached an area directly above the push plate 110. The first media detection sensor 160 may be disposed on the push plate 110. The first media detection sensor 160 may be disposed in the push plate 110 between the first pickup roller 120 and the second pickup roller 130. The first media detection sensor 160 is connected to the controller 700 and may transmit to the controller 700 whether the media bundle 2 has reached the area directly above the push plate 110.

The second media detection sensor 170 may be disposed to be spaced apart from the first media detection sensor 160 in the deposit direction to detect the media bundle 2. The second media detection sensor 170 may be disposed in the push plate 110 to be spaced apart from the first media detection sensor 160 in the deposit direction. In other words, the second media detection sensor 170 may be disposed in the push plate 110 farther from the deposit port 100a than the first media detection sensor 160. Furthermore, the second media detection sensor 170 may be disposed in the push plate 110 closer to the discrimination unit 200 than the first media detection sensor 160. The second media detection sensor 170 may be disposed in the push plate 110 to be spaced apart from the second pickup roller 130 in the deposit direction. The first media detection sensor 160 is connected to the controller 700 and may transmit to the controller 700 that it has detected the media bundle 2.

The conveyance assist roller 180 may convey the media bundle 2 in the deposit direction together with the first pickup roller 120. The conveyance assist roller 180 may be rotatably disposed below the first pickup roller 120 so as not to interfere with the raising and lowering of the push plate 110.

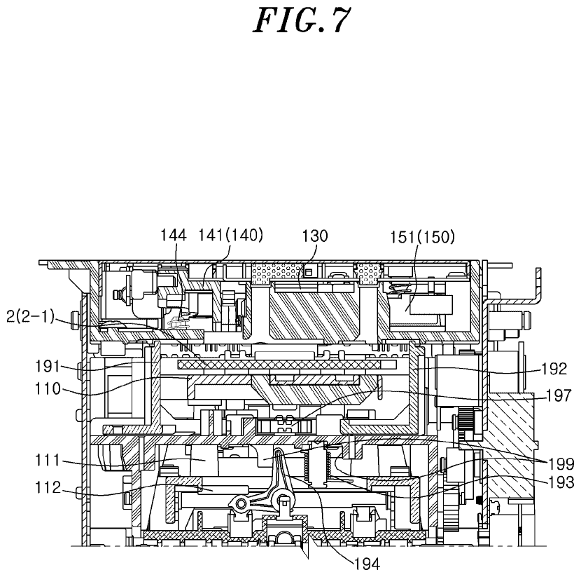

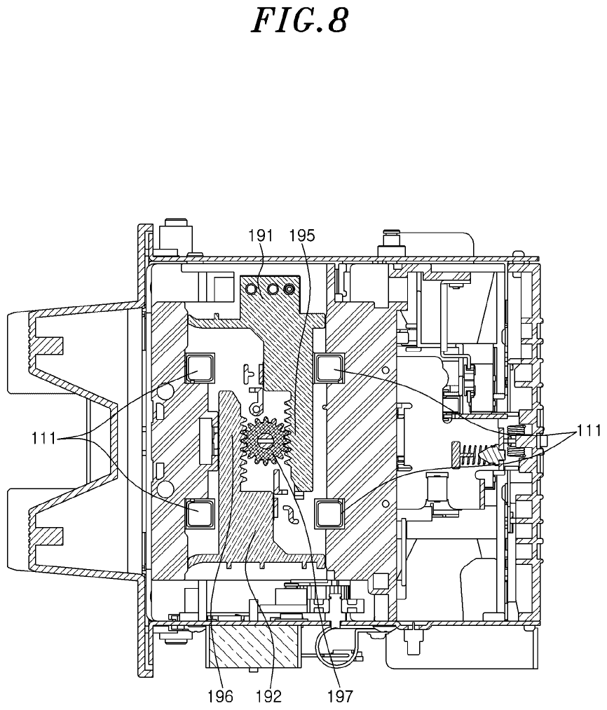

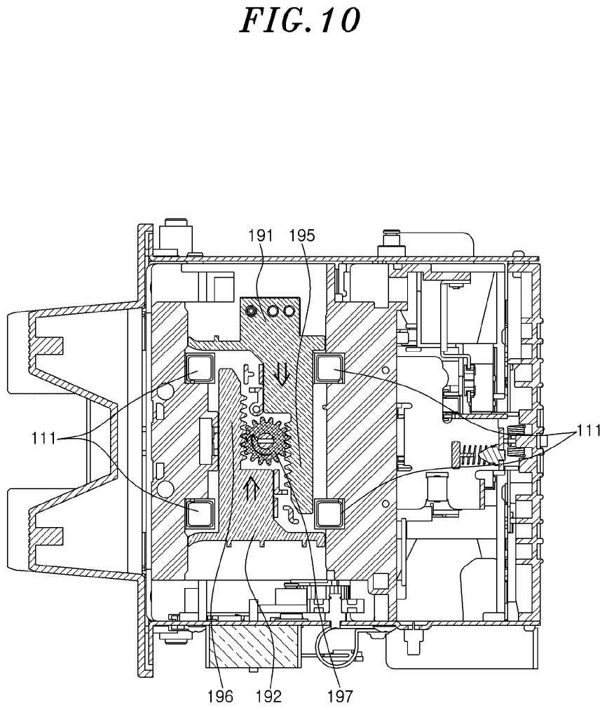

Referring to FIGS. 7 to 10, a media alignment unit 190 may align the media bundle 2 inserted into the deposit and withdrawal unit 100 to the center. The media alignment unit 190 may be configured to operate in conjunction with the raising and lowering of the push plate 110. The media alignment unit 190 may include a first side guide 191, a second side guide 192, a torsion spring 193, a rotating lever 194, a first rack gear 195, a second rack gear 196, and an alignment pinion gear 197.

The first side guide 191 may be disposed on one side of the push plate 110. The first side guide 191 may be moved in the width direction from one side of the push plate 110 toward the center of the push plate 110. By being moved toward the center of the push plate 110, the first side guide 191 may push one side of the media bundle 2 inserted into the deposit and withdrawal unit. A guide support part 199 configured to be elastically pressed by at least a portion of the torsion spring 193 may be formed on the first side guide 191.

The second side guide 192 may be disposed on the other side of the push plate 110. The second side guide 192 may be moved in the width direction from the other side of the push plate 110 toward the center of the push plate 110. By being moved toward the center of the push plate 110, the second side guide 192 may push the other side of the media bundle 2 inserted into the deposit and withdrawal unit. The second side guide 192, together with the first side guide 191, may be moved toward the center of the push plate 110, thereby aligning the media bundle 2 to the center of the push plate 110. The guide support part 199 configured to be elastically pressed by at least a portion of the torsion spring 193 may be formed on the second side guide 192.

The torsion spring 193 may provide an elastic force for moving the first side guide 191 and the second side guide 192 in the width direction of the push plate 110. In other words, the torsion spring 193 may provide an elastic force to at least one of the first side guide 191 and the second side guide 192 in a first direction in which the first side guide 191 and the second side guide 192 move closer to each other. For example, when the first side guide 191 and the second side guide 192 operate in conjunction in directions opposite to each other, the torsion spring 193 may provide an elastic force to either the first side guide 191 or the second side guide 192, and when the first side guide 191 and the second side guide 192 operate independently of each other, the torsion spring 193 may provide an elastic force to each of the first side guide 191 and the second side guide 192.

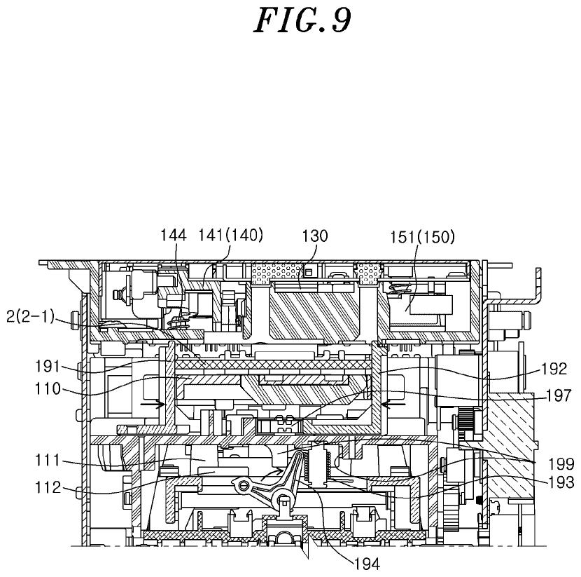

The rotating lever 194 may be rotated in a clockwise or counterclockwise direction in FIG. 9. When the push plate 110 is lowered, the rotating lever 194 may move the first side guide 191 and the second side guide 192 in a second direction in which the first side guide 191 and the second side guide 192 move away from each other. By the rotation of the rotating lever 194, one side of the rotating lever 194 may push one side of the guide support part 199. A portion of the rotating lever 194 may be supported by one side of the guide support part 199. When the push plate 110 is lowered, a portion of the rotating lever 194 may be pressed by the push plate 110 and rotated. When the rotating lever 194 is rotated due to being pressed by the push plate 110, the rotating lever 194 provides a pushing force greater than the elastic force of the torsion spring 193 to the first side guide 191 or the second side guide 192, thereby moving the first side guide 191 and the second side guide 192 in the second direction.

For example, when the push plate 110 is lowered, when one side of the rotating lever 194 is pushed by the plate support protrusion 112 on the plate supporter 111, the rotating lever 194 may be rotated in the counterclockwise direction in FIG. 9, and by the counterclockwise rotation of the rotating lever 194, one side of the rotating lever 194 pushes one side of the guide support part 199, whereby the first side guide 191 may be moved in a second direction in which the first side guide 191 and the second side guide 192 move away from each other. When the push plate 110 is raised, the push by the plate supporter 111 on the one side of the rotating lever 194 is released, and the torsion spring 193 provides an elastic force to the other side of the guide support part 199, whereby the first side guide 191 may be moved in a first direction in which the first side guide 191 and the second side guide 192 move closer to each other.

The first rack gear 195 may be formed on the first side guide 191. The first rack gear 195 may be disposed to face the second rack gear 196. When the first side guide 191 is moved in the width direction of the push plate 110, the first rack gear 195 may transmit the moving force of the first side guide 191 to the second rack gear 196 through the alignment pinion gear 197.

The second rack gear 196 may be formed on the second side guide 192. The second rack gear 196 may be disposed to face the first rack gear 195. The second rack gear 196 may be disposed to be movable in the width direction of the push plate 110. When the second side guide 192 is moved in the width direction of the push plate 110, the second rack gear 196 may transmit the moving force of the second side guide 192 to the first rack gear 195 through the alignment pinion gear 197.

The alignment pinion gear 197 may be disposed between the first rack gear 195 and the second rack gear 196. The alignment pinion gear 197 may be meshed with the first rack gear 195 and the second rack gear 196. When the alignment pinion gear 197 is rotated, the first rack gear 195 and the second rack gear 196 may be moved in the first direction or the second direction, and by the first rack gear 195 and the second rack gear 196, the first side guide 191 and the second side guide 192 may be moved in the first direction or the second direction.

Hereinafter, the operation and effects of the automated teller machine having the above-described configuration will be described.

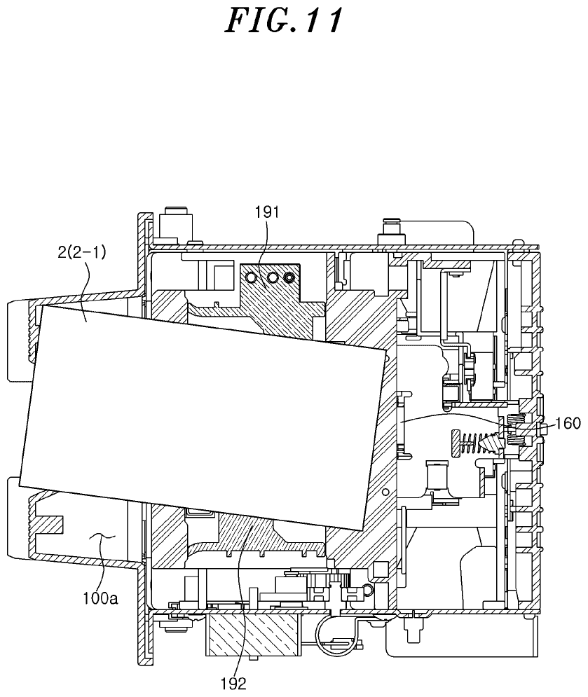

Referring to FIG. 11, when the media bundle 2 is inserted into the deposit and withdrawal unit 100, the first side guide 191 and the second side guide 192 may be positioned in the second direction in which they move away from each other.

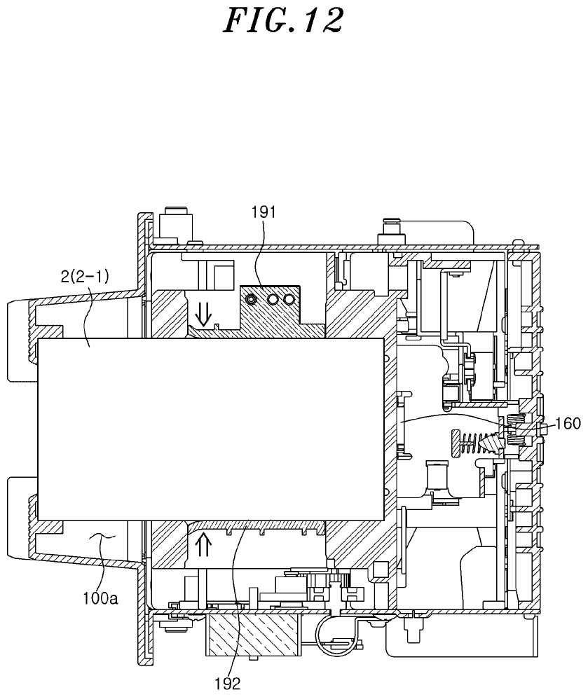

Referring to FIG. 12, when the push plate 110 is raised, the torsion spring 193 may provide an elastic force to at least one of the first side guide 191 and the second side guide 192 in the first direction in which the first side guide 191 and the second side guide 192 move closer to each other. By the elastic force of the torsion spring 193, the first side guide 191 and the second side guide 192 may align the media bundle 2 to the center in the insertion space of the deposit and withdrawal unit.

Meanwhile, when the push plate 110 is lowered, a portion of the rotating lever 194 may be pressed by the push plate 110 and rotated. When the rotating lever 194 is rotated, the rotating lever 194 may move the first side guide 191 and the second side guide 192 in the second direction in which the first side guide 191 and the second side guide 192 move away from each other. For example, when the rotating lever 194 moves the first side guide 191 in the second direction, the first rack gear 195 of the first side guide 191 may move the second rack gear 196 in the second direction through the alignment pinion gear 197, and the second side guide 192 may be moved in the second direction together with the second rack gear 196.

As described above, the automated teller machine according to the embodiment of the present disclosure provides advantages in that when a media bundle is inserted into a deposit and withdrawal unit, a media alignment unit pushes the left and right sides of the media bundle to align the media bundle to the center in an insertion space of the deposit and withdrawal unit. Furthermore, the configuration for separating the media bundle and conveying the media as single sheets is relatively simple.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. An automated teller machine comprising:
a deposit and withdrawal unit configured to allow a media bundle, in which a plurality of media are stacked, to be deposited or withdrawn;
a discrimination unit configured to discriminate the media; and
a controller configured to control the deposit and withdrawal unit and the discrimination unit,
wherein the deposit and withdrawal unit includes:
a push plate arranged to be vertically movable so that the media bundle may be placed thereon; and
a media alignment unit disposed to be movable in a width direction of the push plate and configured to align the media bundle to a center of the push plate by moving in the width direction of the push plate in conjunction with raising and lowering of the push plate.

2. The automated teller machine of claim 1, wherein the media alignment unit comprises:
a first side guide disposed in one side of the push plate and movable in the width direction of the push plate;
a second side guide disposed in the other side of the push plate and movable in the width direction of the push plate;
a torsion spring for providing an elastic force to at least one of the first side guide and the second side guide in a first direction in which the first side guide and the second side guide move closer to each other; and
a rotating lever for moving the first side guide and the second side guide in a second direction in which the first side guide and the second side guide move away from each other when the push plate is lowered.

3. The automated teller machine of claim 2, further comprising:
a first rack gear formed on the first side guide;
a second rack gear formed on the second side guide; and
an alignment pinion gear engaged with the first rack gear and the second rack gear,
wherein the alignment pinion gear, when rotated, interlockingly moves the first side guide and the second side guide in the first direction or the second direction.

4. The automated teller machine of claim 2, wherein the first side guide or the second side guide is supported to be elastically pressed by at least a portion of the torsion spring.

5. The automated teller machine of claim 4, wherein the rotating lever, when the push plate is lowered, provides a pushing force greater than an elastic force of the torsion spring to the first side guide or the second side guide so that the first side guide and the second side guide move in the second direction.

6. The automated teller machine of claim 1, wherein the deposit and withdrawal unit further comprises:
a first pickup roller for conveying the media bundle in a media deposit direction when the media bundle is placed on the push plate;
a second pickup roller spaced apart from the first pickup roller in the deposit direction and configured to supply the media of the media bundle to a single sheet conveyance unit;
a first media detection sensor for detecting whether at least a portion of the media bundle has reached an area directly above the push plate;
a second media detection sensor for detecting whether at least a portion of the media bundle has reached a standby state before being fed into the single sheet conveyance unit;
a first elevating drive unit for raising and lowering the first pickup roller; and
a second elevating drive unit for raising and lowering the second pickup roller.

7. The automated teller machine of claim 6, wherein the controller controls the first elevating drive unit to lower the first pickup roller to contact the media bundle when the first media detection sensor detects the media bundle, and controls the second elevating drive unit to lower the second pickup roller to contact an upper surface of the media bundle and to raise the push plate to push the media bundle upward when the second media detection sensor detects the media bundle.
